(19) United States
(12) Patent Application Publication
(10) Pub. No.: US 2009/0277524 A1
(43) Pub. Date: Nov. 12, 2009

(54) Ascending pipeline for conveying thick substances

(76) Inventors: Andreas Benz, Wendlingen (DE); Christian Stirm, Aichwald (DE); Dietmar Fügel, Wolfschlugen (DE)

Correspondence Address: COLLARD & ROE, P.C., 1077 NORTHERN BOULEVARD, ROSLYN, NY, 11576, US

(21) Appl. No.: 11/919,170

(22) PCT Filed: Mar. 31, 2006
(86) PCT No.: PCT/EP2006/002928

§ 371 Date: Oct. 24, 2007

(30) Foreign Application Priority Data
Apr. 26, 2005 (DE) 10 2005 019 648.9

(51) Int. Cl. E04G 21/04; F16L 3/18; F16L 3/12; F16L 3/22; F16L 3/10; E21B 19/00

(52) U.S. Cl. 138/108; 138/103; 138/106; 137/615; 248/65; 248/68.1; 254/30

(57) ABSTRACT

A damping device (1), particularly for a dual mass flywheel, comprising a first component (2) and a second component and a friction device (4) arranged therebetween, wherein the second component has two distanced surfaces (5, 6) and the first component is arranged between the surfaces, also comprising a third component (8) which is also arranged between the surfaces. When the third component and first component move towards each other, they are braced in such a way that surfaces of the first and third component are pressed against surfaces of the second component.

The invention relates to an ascending pipeline for conveying thick substances, in accordance with the preamble of claim 1, as well as to a device for attaching an ascending pipeline for thick substances, in accordance with the preamble of claim 25, and a lifting device in accordance with the preamble of claim 35.

Ascending pipelines of the type stated initially are particularly used in the construction of tall structures, such as high-rise buildings or reservoir dams. They run upward vertically or at a slant, and serve to transport liquid concrete to a location of use that is situated at a great height. In this connection, the height of the ascending pipeline increases with the height of the structure, in that another pipe is attached at its upper end, when the location of use of the concrete being transported moves to a greater height. Known ascending pipelines are fixed in place on the lower regions of the structure that have already been finished in terms of concrete work. For this purpose, pipe clamps, so-called bridles, are laid around the pipeline and fixed in place on the structure. However, there is the problem that the walls and ceilings of the structure sink as the concrete dries. This effect is all the greater, the higher the structure. However, sinking of the walls and ceilings leads to stresses in the ascending pipeline affixed to them, which stresses are all the greater, the higher the structure. Likewise, a change in the length of the ascending pipeline, which is caused by temperature changes or by the pressure caused by the connected concrete pump, for example, will also lead to stresses in the ascending pipeline affixed to the structure. In order to replace a single damaged or worn pipe, it is furthermore necessary to disassemble a major portion of the ascending pipeline.

It is therefore the task of the invention to make means available for at least reducing the stresses in the ascending pipeline in the case of relative movements of the ascending pipeline with regard to the structures. Another task of the invention consists in creating a better possibility of replacing individual pipes.

This task is accomplished, according to the invention, by means of an ascending pipeline having the characteristics of claim 1, as well as by an attachment device having the characteristics of claim 25. The lifting device having the characteristics of claim 35 allows the replacement of individual pipe segments, without having to disassemble the entire ascending pipeline.

The invention is based on the idea that the pipes of the ascending pipeline are movably guided in the axial direction, with regard to the structure. The guide elements form a movable bearing in which the pipes, in each instance, are accommodated. Sinking of the structure, which brings about sinking of the guide elements fixed in place on it, has no effect or only a slight effect on the ascending pipeline, because the guide element is displaced with regard to the pipe accommodated in it. Likewise, stresses in the ascending pipeline, which result from length changes of the pipeline due to temperature variations or varying pressure of the thick-matter pump, are reduced.

The displaceability of the pipes with regard to the guide elements is particularly important in the upper regions of the structure, in which clear sinking takes place as a result of the drying process of the concrete. It can therefore be provided that only the uppermost pipes are axially displaceable in a guide element. However, it is preferred that each of the pipes situated above the pipe supported in the fixed bearing is guided to be axially displaceable in a guide element fixed in place on the structure. In this way, stresses are avoided, to a great extent, even in the lower pipes of the ascending pipeline.

The at least one guide element advantageously has at least two parts that delimit a passage opening for the related pipe, which can be separated from one another and from the structure. This allows simple assembly of the guide element. It is practical if the at least one guide element is equipped with slide elements that rest against the pipe, in the region of the passage opening. These preferably consist of a plastic resistant to friction wear, having low friction coefficients, whereby polyamide is preferred, at least on a slide surface that rests against the pipe. In this way, it is avoided that the pipe is damaged during a relative movement with regard to the guide element, which preferably consists of a hard material such as metal. Furthermore, the slide elements serve for noise insulation, so that a transfer of the noise produced during the pumping process to the structure is at least made more difficult. It is advantageous if the at least one guide element comprises a guide plate that consists of at least two plate segments, which plate segments are releasably connected with one another and delimit the passage opening. The guide elements can be mounted, to a ceiling of a floor, at an opening through this ceiling, in each instance, or to a bracket that is affixed to a wall of the structure.

It is practical if one of the pipes has a circumferential outside bead. It is advantageous if this pipe is surrounded by a two-part pressure plate, whereby the two parts of the latter at least partially surround the pipe, in each instance. The circumferential outside bead rests on the pressure plate. The bearing is preferably a bearing block that has a slotted, horizontally disposed contact plate for laying the pressure plate on, whereby its slot has a width that is greater than the diameter of the lowermost pipe. It is practical if the bearing block is fixed in place on the structure, preferably in the foundation or on one of the lowermost floors. It is practical if a profile for fixing the pressure plate in place in the horizontal direction is affixed to the contact plate. When the ascending pipeline is put together, the lowermost pipe is introduced into the slot of the contact plate and surrounded by the pressure plate. Subsequently, the pressure plate is laid onto the contact plate, within the profile, and the circumferential outside bead of the lower pipe is laid onto the pressure plate.

Alternatively, the fixed bearing can have two rails set onto the ceiling of a floor at a distance from one another, and a fixation plate set onto the rails, with an opening for passing the pipe provided with the outside bead through. In this connection, the pressure plate is fixed in place on the fixation plate. It is practical if the pressure plate, the fixation plate, and the rails are releasably connected with one another by means of screws. Since the weight of the ascending pipeline rests on the rails, it is distributed over a larger area. The rails can be passed through wall openings of the structure, to better attach them to the structure. It is practical if they consist of steel.

It is practical if at least one of the pipes is provided with a securing element, above and at a distance from a guide element, which securing element projects beyond the outer surface of the pipe to such an extent that it cannot be passed through the passage opening. If the ascending pipeline breaks, the securing element prevents the pipes situated above the breakage point from slipping through the guide elements in a downward direction, and possibly causing significant damage in the structure. The securing element is preferably set onto the pipe with force fit.

According to an advantageous further development, one of the pipes is provided with a slide for closing it. When the pumping process ends, the ascending pipeline is still completely filled with thick matter. In the case of use in a high structure, this can represent a significant amount of thick matter. After the pipe is closed by means of the slide, the connected thick-matter pump can be removed, and the residual thick matter remaining in the ascending pipeline can be let down, in controlled manner, into containers made available for this purpose, or into the foundation of the structure. For this purpose, it is practical if the slide is disposed bellow the fixed bearing.

It is advantageous if the pipes are connected with one another by means of pipe couplings that project radially beyond their outer surface. The pipe couplings are preferably formed by flanges affixed to the pipes at their ends, and clamping rings that connect the flanges. This represents a connection between the pipes that can easily be released. Furthermore, it is easy to grasp the pipe coupling that projects beyond the outer surface of the pipes, to lift the ascending pipeline or individual pipes. It is practical if the lowermost pipe is connected with a thick-matter pump by way of a feed line.

The lifting device according to the invention makes it possible to replace individual pipes. For this purpose, the cuff is laid against a pipe, surrounding it. Then, the cuff is lifted by means of the lifting mechanism that is supported on the ground surface, causing force to be applied to a pipe coupling that lies radially above the outer surface of the ascending pipeline, and the coupling to be lifted. If the next lowermost pipe coupling is loosened, a part of the ascending pipeline can therefore be lifted. This is particularly advantageous if the pipes engage into one another by a certain distance at the coupling locations. It is practical if the cuff has a round cross-section and if its inside diameter is less than the outside diameter of the pipe coupling. The lifting mechanism preferably has at least one hydraulic cylinder. It is particularly preferred if the lifting mechanism has a divisible support plate for the cuff, with a passage opening for one of the pipe segments, on the underside of which hydraulic cylinders for lifting the support plate with regard to the ground surface are affixed. The hydraulic cylinders can develop great power, by means of applying pressure from a hydraulic pump. The lifting device according to the invention can be used for conventional ascending pipelines, whereby an attachment of the parts of the ascending pipeline to be lifted on the structure first has to be released. However, the use of the lifting device is particularly advantageous for an ascending pipeline having axially displaceable pipes according to the invention, since these can be lifted without releasing an attachment between building and ascending pipeline.

In the following, the invention will be explained in greater detail using an exemplary embodiment shown schematically in the drawing. This shows:

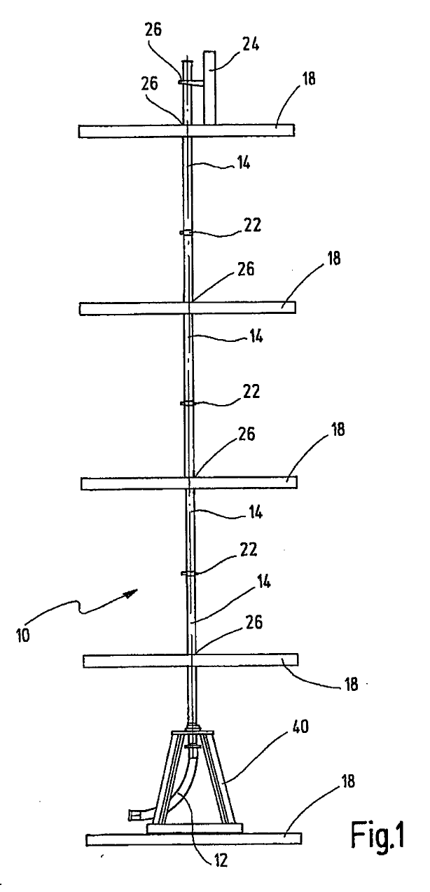

FIG. 1 a schematic representation of an ascending pipeline passing through several floors of a building, for thick substances, in accordance with a first exemplary embodiment;

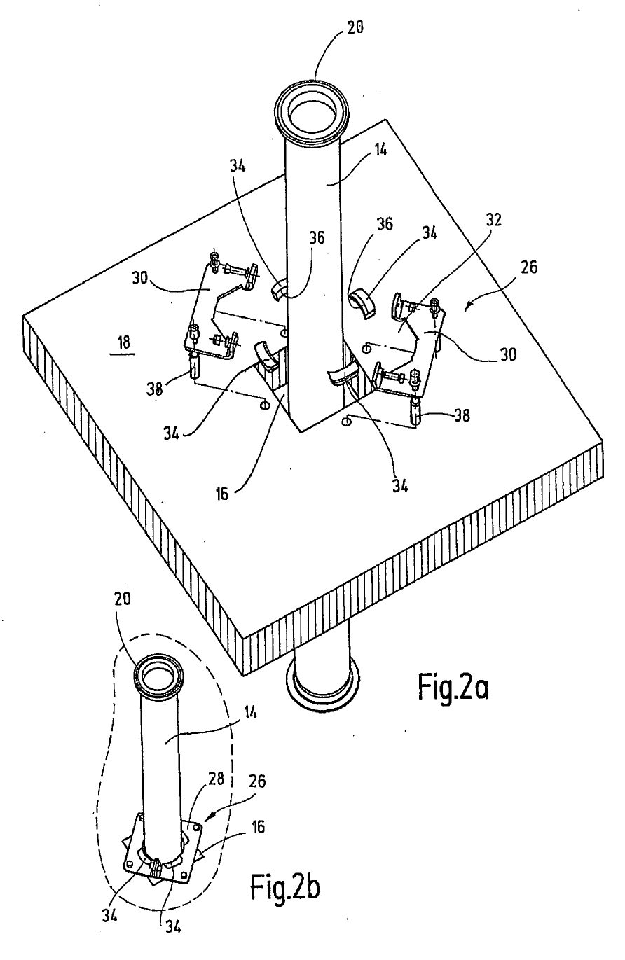

FIGS. 2a, b the attachment of a pipe to a ceiling opening in an exploded view, and in the assembled state;

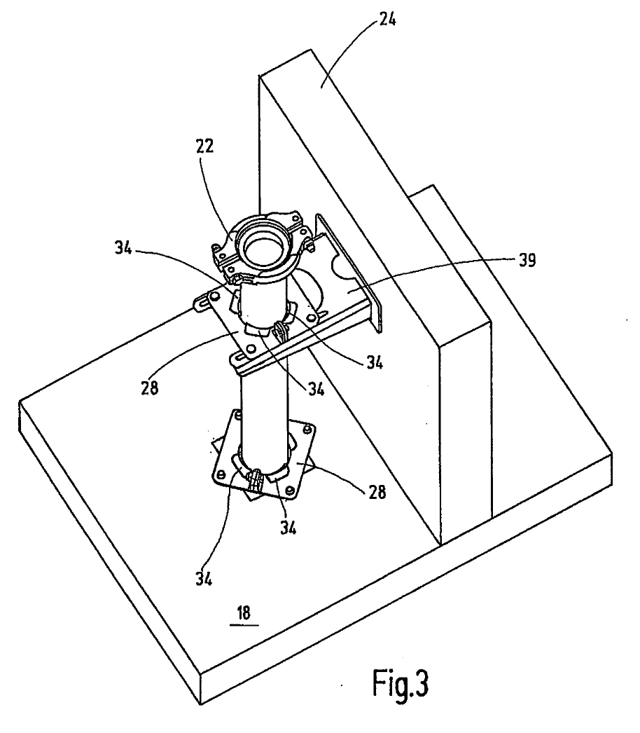

FIG. 3 an alternative attachment of a pipe to a building wall;

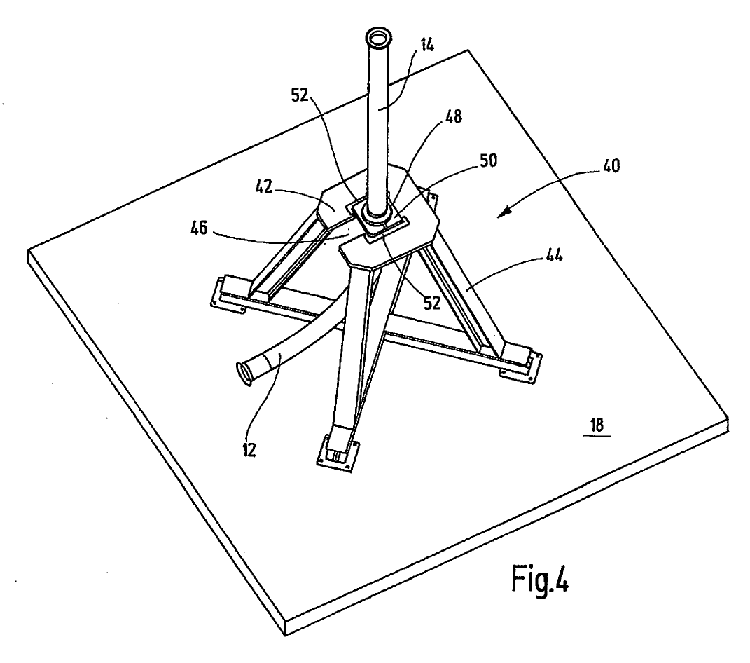

FIG. 4 the attachment of the lowermost pipe of the ascending pipeline according to FIG. 1;

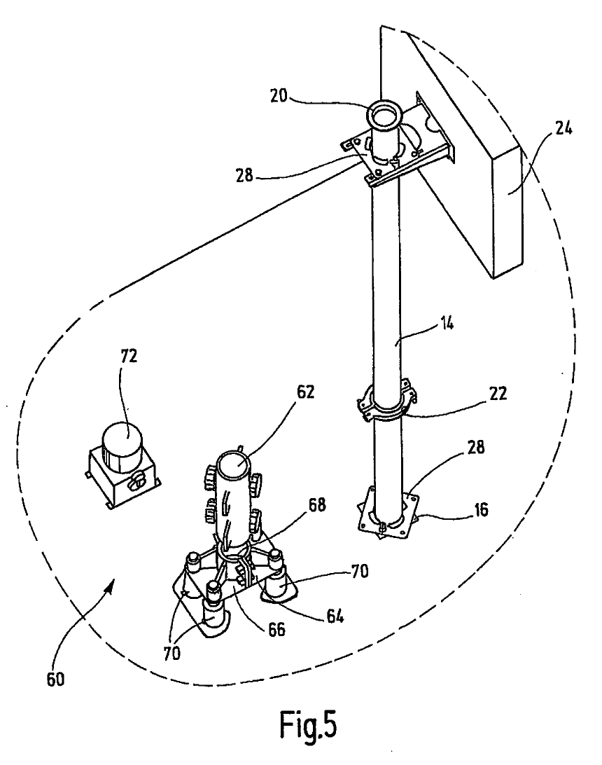

FIG. 5 a lifting device;

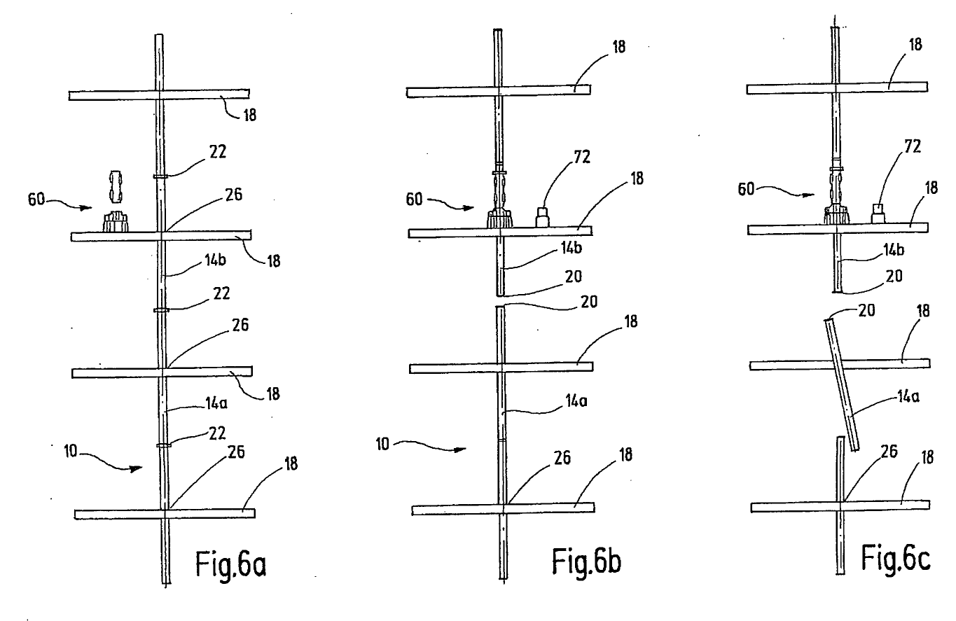

FIGS. 6a, b, c a schematic representation of the replacement of a pipe;

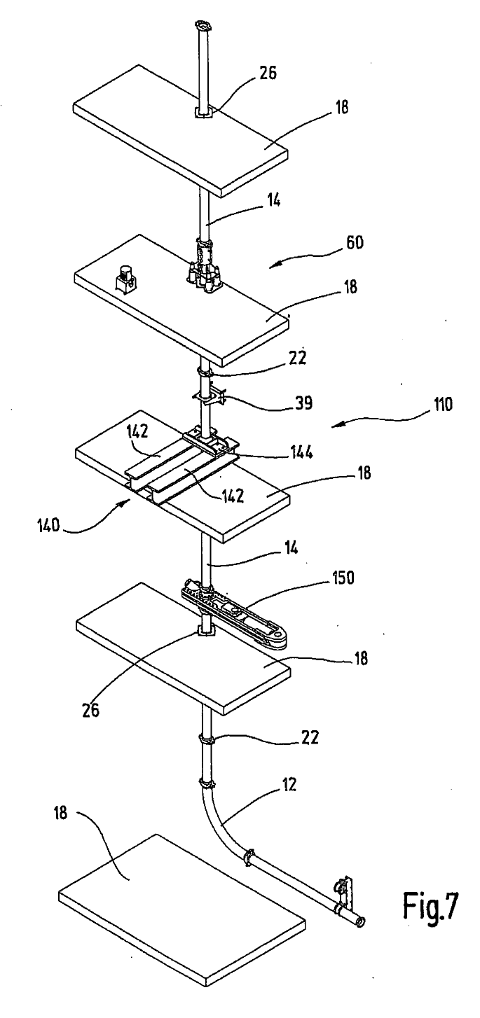

FIG. 7 a schematic representation of an ascending pipeline passing through several floors of a building, for thick substances, in accordance with a second exemplary embodiment;

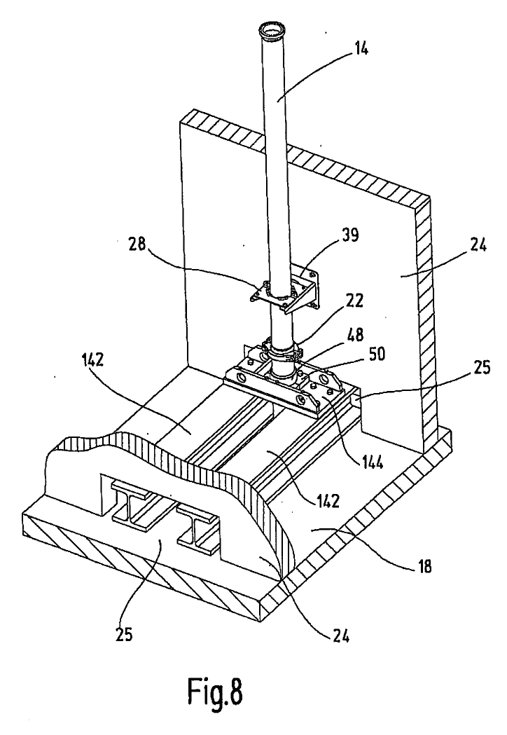

FIG. 8 a fixed bearing of the ascending pipeline according to FIG. 7;

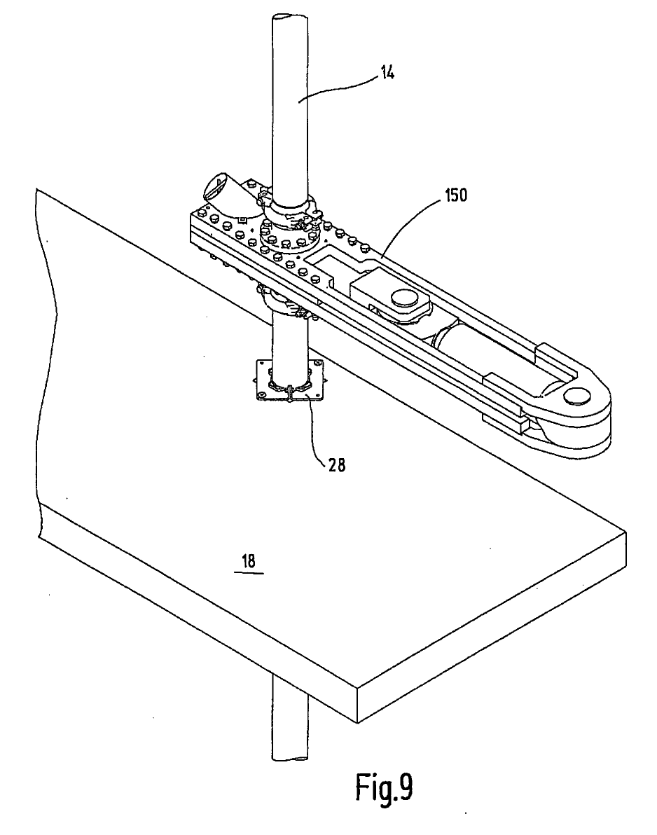

FIG. 9 a slider for closing the ascending pipeline according to FIG. 7; and

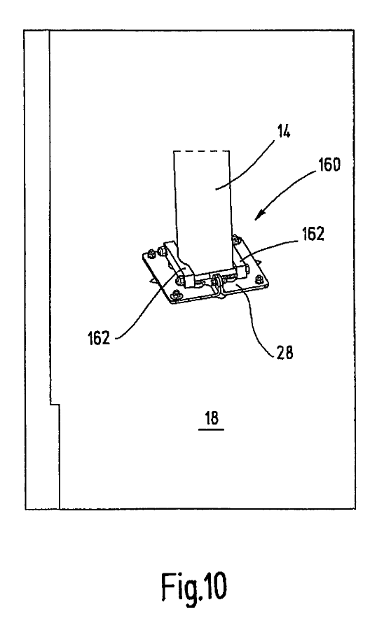

FIG. 10 a securing element for the ascending pipeline according to FIG. 7.

An ascending pipeline 10 (FIG. 1) for thick substances is passed through several floors of a building and serves to convey liquid concrete from a feed line 12 to a location of use at a great height, by means of a concrete pump. The ascending pipeline 10 is formed from several pipes 14 lined up with one another in the longitudinal direction, which are passed through ceiling openings 16 in the ceilings 18 of several floors. At their ends, the pipes 14 have flanges 20 that project beyond their outer surfaces, at which they are connected with one another by means of clamping rings 22. The pipes 14 engage into one another by a certain distance at the flanges 20.

In the region of the ceiling openings 16, the pipes 14 are attached to the ceilings 18 of the floors. Furthermore, the pipes 14 can be attached to building walls 24 (FIG. 3). The attachment axially displaceable. Thus, the guide elements 26 form movable bearings for the ascending pipeline 10.

The lowermost of the pipes 14 is affixed to a bearing block 40, as a fixed bearing, which block is attached to the ceiling 18 of one of the lowermost floors (FIG. 4). The bearing block 40 has a contact plate 42, which is affixed to a frame 44. The contact plate 42 has a slot 46, the width of which is greater than the outside diameter of the pipe 14. The lowermost pipe 14 carries a circumferential bead 48, which rests on a pressure plate 50 that consists of two halves. The pressure plate 50 in turn rests on the contact plate 42, and is secured to prevent slipping in the horizontal direction by means of an accommodation profile 52 on the top of the contact plate 42. The lowermost pipe 14 is connected to the feed line 12, which leads to a concrete pump, not shown.

To replace individual pipes 14, a lifting device 60 is provided (FIG. 5), which has a divisible cuff 62 that is laid around one of the pipes 14. The cuff 62 rests on a lifting mechanism 64, which has a support plate 66 with a passage opening 68 for the pipe 14. On the underside of the support plate 66, four hydraulic cylinders 70 are affixed, to which pressure can be applied by means of a hydraulic pump 72. To replace a defective pipe 14a of the pipes 14 to ceilings 18 of floors and building walls 24 takes place by means of guide elements 26. The guide elements 26 have a guide plate 28, in each instance, which consists of two plate segments 30 releasably connected with one another, which leave a passage opening 32 for a pipe 14 in the assembled state. Each of the plate segments 30 surrounds a pipe 14 by half, so that the pipe 14 is accommodated in the passage opening 32 of the guide plate 28.

The guide plate 28 has attachment means 38 with which it is firmly anchored in the ceiling 18 of the floor. When the guide element 26 is affixed to one of the building walls 24, the guide plate 28 is mounted on a bracket 39 that is fixed in place on the building wall 24. The bracket 39 has accommodations for the attachment means 38, which allow affixing the guide plate 28 at a variable distance from the building wall 24. The guide plate 28 is provided with slide elements 34 that project into the passage opening 32. These elements are made from polyethylene and thereby demonstrate a lower friction coefficient and, at the same time, a greater resistance to friction wear. The slide elements 34 rest against the pipe 14 with a slide surface 36, in each instance, so that the pipe is fixed in place almost immovably in a horizontal plane by means of the guide element 26, but is guided to be (FIG. 6a, to 6c), first the clamping ring 22 at its upper flange is loosened. The cuff 62 is placed on the pipe 14b that lies above, and lifted upward by means of the lifting mechanism 64, until it comes to rest on the next upper pipe coupling, i.e. on its clamping ring 22. Further lifting of the cuff 62 brings about lifting of the upper pipe 14b from the defective pipe 14a. This can then be removed and replaced with a replacement part. For this purpose, the guide element 26 that accommodates the defective pipe 14a can be removed.

The ascending pipeline 110 according to the second exemplary embodiment (FIG. 7) differs from the ascending pipeline 10 according to the first exemplary embodiment mainly in the configuration of the fixed bearing. The same components are therefore provided with the same reference symbols as in the case of the first exemplary embodiment. In place of the bearing block 40, a fixed bearing 140 (FIG. 8) is provided, which has two steel rails 142 disposed parallel at a distance from one another, which are laid onto the ceiling 18 of a floor. The ends of the steel rails 142 are passed through wall openings 25 and thereby fixed in place on the building. A fixation plate 144 is screwed onto the steel rails 142, which plate has an opening for passing through a pipe 14, whereby the opening is disposed above the interstice between the steel rails 142. As in the case of the first exemplary embodiment, the pipe 14, which is provided with an outside bead 48, is, surrounded by a two-part pressure plate 50, which is screwed onto the fixation plate 144. In contrast to the first exemplary embodiment, the pipe 14 that is provided with the outside bead 48, which supports the ascending pipeline 110 on the fixed bearing 140, is not a normal transport pipe. Instead, it is an intermediate piece that is shorter than the other pipes 14 and that merely serves for support in the fixed bearing 140. In contrast to the first exemplary embodiment, the fixed bearing 140 is not disposed in the foundation of the building, but rather on the ceiling 18 of one of the lower floors.

Below the fixed bearing 140, one of the pipes 14 is provided with a slide 150 (FIG. 9), by means of which the pipe 14 can be closed off. Liquid concrete that is still situated in the ascending pipeline 110 when the pumping process ends can be let down by means of the slide 150. For this purpose, the slide 150 is first closed, so that the column of liquid concrete situated above the slide 150 cannot escape downward. Subsequently, the concrete pump is uncoupled from the feed line 12, whereby any liquid concrete situated in the ascending pipeline 110 below the slide 150 runs out. Finally, the slide 150 is opened, and the remaining liquid concrete flows through, the feed line 12, either into containers that have been made available, or into the building, to pour concrete into the foundation.

To secure the ascending pipeline 110, securing elements 160 are set onto the pipes 14 at intervals, above the guide elements 26 (FIG. 10). These consist of two clamps 162 held together by means of screws, which are set onto the outside surface of the pipe 14. The clamps 162 project so far beyond the outer surface of the pipe 14 that they cannot pass through one of the passage openings 32. If the ascending pipeline 110 breaks, the securing element 160 prevents the parts of the ascending pipeline 110 that are situated above the break location from slipping through, in that it hits against the guide plate 28.

In summary, the following should be stated: The invention relates to an ascending pipeline 10; 110 for conveying thick substances, particularly liquid concrete, for constructing a structure, having several pipes 14 that are releasably connected with one another at coupling points and are disposed one behind the other in a longitudinal direction of the pipeline. According to the invention, it is provided that at least one of the pipes 14 is supported in a fixed bearing 40; 140, and that at least one other pipe 14 is guided, in axially displaceable manner, in a guide element 26 mounted on the structure in fixed manner.

1. Ascending pipeline for conveying thick substances, particularly liquid concrete, for constructing a structure, having several pipes (14) that are releasably connected with one another at coupling points and are disposed one behind the other in a longitudinal direction of the pipeline, wherein at least one of the pipes (14) is supported in a fixed bearing (40; 140), and that at least one other pipe (14) is guided, in axially displaceable manner, in a guide element (26) mounted on the structure in fixed manner.

2. Ascending pipeline according to claim 1, wherein the lowermost pipe (14) is supported in the fixed bearing (40; 140), and that the pipes (14) situated above it are guided to be axially displaceable in guide elements (26) mounted in fixed manner on the structure.

3. Ascending pipeline according to claim 1, wherein a pipe (14) situated above the lowermost pipe (14) is supported in the fixed bearing (40; 140).

4. Ascending pipeline according to claim 1, wherein the at least one guide element (26) has at least two parts (30) that delimit a passage opening (32) for the related pipe (14) and can be separated from one another and from the structure.

5. Ascending pipeline according to claim 4, wherein the at least one guide element (26) is equipped with slide elements (34) that lie against the pipe (14), in the region of the passage opening (32).

6. Ascending pipeline according to claim 5, wherein the slide elements (34) consist of a plastic resistant to friction wear, having low friction coefficients, preferably of polyamide, at least on a slide surface (36) that rests against the pipe (14).

7. Ascending pipeline according to claim 1, wherein the at least one guide element (26) comprises a guide plate (28) that consists of at least two plate segments (30), which plate segments (30) are releasably connected with one another and delimit the passage opening (32).

8. Ascending pipeline according to that claim 1 wherein at least one of the guide elements (26) is mounted to a ceiling (18) of a floor, at an opening (16) through it.

9. Ascending pipeline according to that claim 1, wherein at least one of the guide elements (26) is mounted on a bracket (39) that is fixed in place on a wall (24) of the structure.

10. Ascending pipeline according to claim 1, wherein one of the pipes (14) has a circumferential outside bead (48).

11. Ascending pipeline according to claim 10, comprising a two-part pressure plate (50), the two parts of which partly surround the pipe (14) provided with the outside bead (48), in each instance, and on which the outside bead (48) rests.

12. Ascending pipeline according to claim 11, that wherein the fixed bearing (40) is a bearing block that has a slotted, horizontally disposed contact plate (42) for laying the pressure plate (50) on, whereby its slot (46) has a width that is greater than the diameter of the pipe (14) provided with the outside bead (48).

13. Ascending pipeline according to claim 12, wherein the contact plate (42) has a profile (52) for fixing the pressure plate (50) in place in the horizontal direction.

14. Ascending pipeline according to claim 12, wherein the bearing block (40) is connected with the structure in fixed manner.

15. Ascending pipeline according to claim 11, wherein that wherein the fixed bearing has two rails (142), preferably steel rails, set onto the ceiling of a floor at a distance from one another, and a fixation plate (144) set onto the rails (142), with an opening for passing the pipe (14) provided with the outside bead (48) through.

16. Ascending pipeline according to claim 15, wherein the pressure plate (50), the fixation plate (144), and the rails (142) are releasably connected with one another by means of screws.

17. Ascending pipeline according to claim 15, wherein the rails (142) are passed through wall openings (25) of the structure with their ends.

18. Ascending pipeline according to claim 4, wherein at least one of the pipes (14) is provided with a securing element (160), above and at a distance from a guide element (26), which securing element projects beyond the outer surface of the pipe to such an extent that it cannot be passed through the passage opening (32).

19. Ascending pipeline according to claim 18, wherein the securing element (160) is set onto the pipe (14) with force fit.

20. Ascending pipeline according to claim 1, wherein one of the pipes (14) is provided with a slide (150) for closing it.

21. Ascending pipeline according to claim 20, wherein the slide (150) is disposed below the fixed bearing (40; 140).

22. Ascending pipeline according to claim 1, wherein the pipes (14) are connected with one another, at the coupling locations, by means of pipe couplings (20, 22) that project radially beyond their outer surface.

23. Ascending pipeline according to claim 22, wherein the pipe couplings are formed by flanges (20) affixed to the pipes (14) at their ends, and clamping rings (22) that connect the flanges (20).

24. Ascending pipeline according to claim 1, wherein the lowermost pipe (14) is connected with a thick-matter pump by way of a feed line (12).

25. Device for attaching an ascending pipeline (10; 110) formed from pipes (14) that are releasably connected with one another at coupling points and are disposed one behind the other in a longitudinal direction of the pipeline, particularly for liquid concrete, to a structure, comprising at least one guide element (26) that can be fixed in place on a floor ceiling (18) or wall (24) of the structure, to guide one of the pipes (14), which pipe can be accommodated in the guide element (26) to be axially displaceable.

26. Attachment device according to claim 25, wherein it has at least one guide element (26), in each instance, for a number of pipes (14), preferably for every pipe (14).

27. Attachment device according to claim 25, wherein the at least one guide element (26) has at least two parts (30) that delimit a passage opening (32) for the related pipe (14), and can be separated from one another and from the building.

28. Attachment device according to claim 27, wherein the at least one guide element (26) is equipped with slide elements (34) that can be laid against the pipe (14), in the region of the passage opening.

29. Attachment device according to claim 28, wherein the slide elements (34) consist of a plastic resistant to friction wear, having low friction coefficients, preferably of polyamide, at least on a slide surface (36) that can be laid against the pipe (14).

30. Attachment device according to claim 25, wherein the at least one guide element (26) comprises a guide plate (28) that consists of at least two plate segments (30), which plate segments are releasably connected with one another to surround the pipe (14).

31. Attachment device according to claim 25, comprising a bearing block (40) that can be attached fixed in place on the structure, for mounting one of the pipes (14) of the ascending pipeline (10).

32. Attachment device according to claim 31, wherein the bearing block (40) has a contact plate (42) having a slot (46), the width of which is greater than the diameter of the pipe (14) to be mounted.

33. Attachment device according to claim 32, comprising a two-part pressure plate (50) for surrounding the pipe (14) to be mounted, and for laying onto the contact plate (42).

34. Attachment device according to claim 25, comprising a fixed bearing (140) for supporting the ascending pipeline (110), which has two rails (142) that can be set onto the ceiling (18) of a floor at a distance from one another, particularly steel rails, and a fixation plate (144) that can be set onto the rails (142), with an opening for passing the pipe (14) through, and a two-part pressure plate (50) for surrounding the pipe (14) and for fixation on the fixation plate (144).

35. Lifting device for an ascending pipeline (10; 110) formed from several pipes (14), whereby the pipes (14) are releasably connected with one another by means of pipe couplings (20, 22) that project radially beyond their outer surface, comprising a cuff (62) for at least partially surrounding a pipe (14) and for applying force to a pipe coupling (20, 22) in the axial direction of the ascending pipeline (10), as well as by a lifting mechanism (64) for lifting the cuff (62) that can be supported on a ground surface that is fixed in place.

36. Lifting device according to claim 35, wherein the cuff (62) has a round cross-section and that its inside diameter is less than the outside diameter of the pipe coupling (20, 22).

37. Lifting device according to claim 35, wherein the lifting mechanism (64) has at least one hydraulic cylinder (70).

38. Lifting device according to claim 37, wherein the lifting mechanism (64) has a divisible support plate (66) for the cuff (62), having a passage opening (68) for one of the pipes (14), on the underside of which hydraulic cylinders (70) for lifting the support plate (66) with regard to the ground surface are affixed.

39. Use of a lifting device according to claim 35 for lifting an ascending pipeline (10; 110).
